(19) United States
(12) Patent Application Publication
(10) Pub. No.: US 2011/0200383 A1
(43) Pub. Date: Aug. 18, 2011

(54) APPLICATOR DEVICE FOR A FLUID

(75) Inventor: Gérard GIEUX, BRUXELLES (BE)

(73) Assignee: FIGIE LUXEMBOURG SA, Luxembourg (LU)

(21) Appl. No.: 13/028,352

(22) Filed: Feb. 16, 2011

(30) Foreign Application Priority Data
Feb. 18, 2010 (FR) 10/51154

(51) Int. Cl. B05C 1/06

(52) U.S. Cl. 401/202; 401/207

(57) ABSTRACT

The invention relates to an applicator device for a fluid including: a body topped with a head, said head having an upper plate with a substantially planar surface and having an outlet orifice to distribute the fluid, said fluid being contained in the body; and a foam applicator mounted on a support, the foam applicator including an annular groove configured to cooperate with a lateral annular protrusion belonging to said support, where the device is configured so that the lower portion of the applicator situated under the annular groove and intended to be in contact with the head is compressed when the support and the foam applicator are mounted on the head of the body.

### TECHNICAL FIELD

The present invention relates to an applicator device for a fluid.

### BACKGROUND

Applicator devices exist in the form of tubes made from extruded plastic, topped with an over-molded plastic head. This head is often provided with a tubule, i.e. a hollow tubular protuberance, penetrating the applicator.

The applicator is generally a foam provided with a through hole in which the tubule is housed.

An additional piece made from injected plastic includes a lateral annular protrusion able to come into a corresponding annular groove of the foam. Said additional piece serves as a support for said foam.

Thus, when the fluid contained in the tube is pressed, said fluid rises in the tubule and passes through the through hole of the foam.

However, in this type of device, the presence of a through hole can cause the flow of fluid between the foam and the head when the fluid is rather liquid, and can thus cause leaks.

The cover closing the assembly is mounted tightened on the applicator support, which can cause unscrewing of the support and the applicator by manipulating the cover.

Moreover, the product flowing through the tubule and the outlet orifice, said product generally does not spread uniformly on the upper surface of the applicator to come into contact with the skin or any other surface. The application of the fluid is therefore not uniform.

Also known is an applicator device for a fluid comprising a flexible plastic tube containing said fluid and topped with an annular wall gripping a foam applicator. In this type of device, the foam is adhered on the head of the tube.

However, it is difficult to obtain a uniform glue deposition, causing a leak of the fluid between the applicator and the pressurized outlet head. The product stagnating at that location can cause microbial growth or mold.

### BRIEF SUMMARY

One aim of the present invention is therefore to provide an applicator device for a fluid allowing a uniform application of said fluid without leak or stagnation of the product contained in the fluid between the head and the applicator while allowing a large choice of materials for the applicator.

To that end, according to one aspect, the invention relates to an applicator device for a fluid including:
a body topped with a head, said head comprising an upper plate with a substantially planar surface and having an outlet orifice to distribute the fluid, said fluid being contained in the body; and
a foam applicator mounted on a support, the foam applicator including an annular groove configured to cooperate with a lateral annular protrusion belonging to said support,

the device being configured so that the lower portion of the applicator situated under the annular groove and intended to be in contact with the head is compressed when the support and the foam applicator are mounted on the head of the body.

The device of the invention comprises ensuring good maintenance of the applicator on the head owing to the compression of the foam. The compression also makes it possible to ensure good sealing between the applicator and the head. As a result, the infiltration and leakage of the fluid between the applicator and the head is avoided.

It is no longer necessary to apply glue to ensure the maintenance of the applicator on the head. As a result, any risk of incompatibility of the glue with the fluid contained in the body is avoided.

Moreover, the device of the invention makes it possible to easily assemble and disassemble the applicator, so that users can access it in order to clean or replace it, if necessary.

Furthermore, different types of materials can be used for the applicator of the device according to the invention.

According to other features of the invention, the device according to the invention includes one or several of the following optional features considered alone or according to all possible combinations:
the support includes an inner shoulder configured to come into contact on the surface of the upper plate when the support is mounted on the head, the height of the space formed by the contact of the inner shoulder on the head being smaller than the height of the lower portion;
the applicator includes a through distribution orifice substantially aligned with the outlet orifice of the head;
the device according to the invention also comprising a cover configured to top the support and provided with a pin configured to come into the distribution orifice;
the upper plate includes, on the substantially planar surface, a protruding ring configured to stress the applicator by shearing;
the protruding ring is assembled on the head;
the support includes teeth on the lateral annular protrusion to maintain the foam applicator;
an opening and closing system is inserted between the support and the head to obstruct or free the outlet orifice of the head;
the head also includes a toroidal ring in relief relative to the surface on which the applicator support is intended to bear;
the foam applicator is made from two different superimposed materials, with different stiffnesses;

the fluid is a cosmetic product, a medicinal product, a soap, a detergent, a glue, a waxing product, a glazing product, a repellant or a paint.

### BRIEF DESCRIPTION OF THE DRAWINGS

The invention will be better understood upon reading the following non-limiting description, done in reference to the appended figures.

FIG. 1 is a partial cross-section of the device according to the invention;

FIG. 2 is a perspective view of the embodiment of FIG. 1;

FIG. 3 is a perspective view of an alternative of the embodiment of FIG. 2;

FIG. 4 is a partial cross-section of an alternative of the embodiment of FIG. 1;

FIG. 5 is a perspective view of the embodiment of FIG. 4;

FIG. 6 is a cross-sectional view of an embodiment of an applicator for a device according to the invention;

FIG. 7 is a partial cross-sectional view of the applicator shown in FIG. 6 mounted on a support and a head of the device according to the invention;

FIG. 8 is an enlargement of the area of the applicator mounted on the head of FIG. 7 and receiving a pin;

FIG. 9 is a cross-sectional view of an alternative embodiment of the applicator of FIG. 7 mounted on a support and a head of the device according to the invention.

### DETAILED DESCRIPTION

As shown in FIG. 1, the applicator device 1 according to the invention for a fluid includes:
a body 3 topped with a head 5, said head 5 comprising an upper plate 8 with a substantially planar surface 7 and having an outlet orifice 9 to distribute the fluid; and
a foam applicator 11 mounted on a support 13, the foam applicator 11 including an annular groove 15 configured to cooperate with a lateral annular protrusion 17 belonging to said support 13,

the device 1 being configured so that the lower portion 19 of the applicator 11 situated under the annular groove 15 and intended to be in contact with the head 5 is compressed when the support 13 and the foam applicator 11 are mounted on the head 5 of the body.

The maintenance of the applicator 11 in the device 1 of the invention no longer requires glue, which makes it possible to avoid any risk of incompatibility of the glue with the fluid contained in the body 3.

More precisely, the support 13 includes an inner shoulder 18 configured to come into contact on the surface 7 of the plate of the head when the support 13 is mounted on the head 5. The height of the space formed by the contact of the inner shoulder 18 on the head 5 is smaller than the height of the lower portion 19. “Height” refers to the dimension collinear to the longitudinal axis 20 of the device 1 according to the invention. “Transverse” refers to the direction substantially perpendicular to the longitudinal axis 20. “Longitudinal” refers to the direction substantially collinear to the longitudinal axis 20.

Thus, when the support 13 is mounted on the head 5, the lower portion 19 compresses on the plate 8 of the head.

Typically, the height of the space formed by the contact of the inner shoulder 18 on the head 5 is between 2 mm and 10 mm. The height of said space can vary homothetically as a function of the dimensions of the device according to the invention 1.

Typically, the height of the lower portion 19 is between 3 mm and 15 mm.

According to one embodiment, the largest length of the inner shoulder 18 can be smaller than the largest length of the lower portion 19. The largest length is taken in a plane perpendicular to the longitudinal axis 20. In the case where the transverse section of the applicator and the support is substantially circular, the largest length of the inner shoulder 18 is the largest diameter thereof that is smaller than the outer diameter of the lower portion 19. Thus, said lower portion 19 can be compressed radially in order to still further improve the sealing of the device 1 according to the invention.

The fluid can be more or less liquid. Said fluid can in particular be a cosmetic product, such as a foundation, a depilatory fluid, sunscreen, hair dye, deodorant, or skin care. The fluid can also be a medicinal product, in particular a dermatological product, a soap, detergent, paint, glue, waxing product, in particular for shoes, a glazing product, or a repellent. The device according to the invention 1 can therefore be applied on the skin or on any other surface as a function of the fluid to be applied.

The body 3 can assume the form of a flexible tube, a plastic or metal-plastic bottle, obtained by extrusion or injection.

As shown in FIG. 3, the body 3 can be in the form of a bottle, for example made from plastic using a hot blowing method.

The body 3 can have, along the longitudinal axis 20, an oval or round transverse section, or a shape with variable sections.

The head 5 can be over-molded on the body 3 forming a container able to receive the fluid. As shown in FIG. 3, in the case of a bottle, an attached piece forming the head 5 can be forcibly mounted in the opening of the bottle via an annular skirt configured to ensure sealing.

The head 5 comprises an outlet orifice 9 for the fluid contained in said body 3, the orifice 9 being situated in the upper plate 8 with substantially planar surface 7. The upper plate 8 can be provided with a protruding ring 21. The protruding ring 21 is intended to go into the foam applicator 11 by deformation thereof in order to stress the latter by compression. The protruding ring 21 can be formed in a single piece with the head 5, thereby forming a single piece therewith, or can be assembled on the latter, thereby forming two separate blocks.

The protruding ring 21 makes it possible, on one hand, to compress the foam so as to create a sealing device; and on the other hand, to help the stretching of the circular rim that is at the intersection between the lower portion 19 and the distribution orifice 41, owing to the compression of the foam. The inlet of the distribution orifice 41 is thereby widened, like a conical bevel. Thus, by compressing the foam, one avoids blocking said distribution orifice 41. Moreover, the passage of the fluid contained in the body 3 outside the latter is made easier.

The protruding ring 21 typically has a height between 2 mm and 9 mm.

The head 5, in particular the upper plate 8, can also include a toroidal ring 23 in relief relative to the surface 7 on which the support 13 bears. Owing to this toroidal ring 23, the vertical tightening force is concentrated on a single generatrix. The elastic deformation of said toroidal ring 23 makes it possible to reinforce the sealing.

The support 13 can be made by plastic injection. Said support 13 can include a screw pitch 31 configured to cooperate with the corresponding screw pitch 33 provided on the head 5. In the event of the presence of screw pitches 31 and 33, the compression of the lower portion 19 can be done by screwing the support 13 on the upper plate 8.

In this embodiment, the support 13 is configured to be screwed on the head 5, until the inner shoulder 18 of the support 13 comes into contact on the upper plate 8 of the head of the tube.

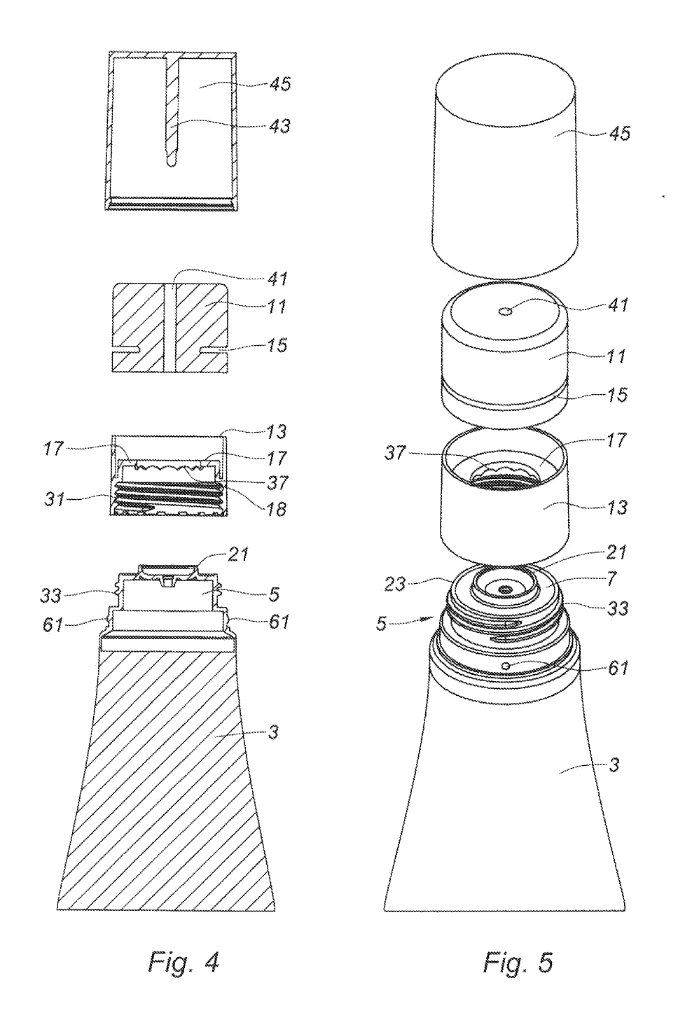

According to the embodiment illustrated in FIGS. 4 and 5, the support 13 can include teeth 37 on the lateral annular protrusion 17 to maintain the foam applicator 11. Such teeth 37 are configured to penetrate the applicator 11 so as to prevent it from rotating during assembly or disassembly.

The foam applicator 11 can be made from various types of materials.

The foam can be a foam comprises PU (polyurethane), NBR (nitrile butadiene rubber), SBR (styrene butadiene rubber), polyester, cellulose, PE (polyethylene), and/or EVA (ethylene vinyl alcohol).

The foam can also be covered with glued synthetic hairs, also called flocking, to as to soften the contact.

As illustrated in FIG. 9, the foam applicator 11 can also be made from two different materials, the first material being able to modify the rigidity of the foam and the second being able to ensure pleasant contact with the skin.

More particularly, the material M1 intended for the application of fluid, called upper material, can be a flexible and soft material that is pleasant to the touch and provides for comfortable application when the fluid contained in the body 3 is a cosmetic or medicinal product in particular.

The lower material M2 intended to be partially compressed when the support 13 and the applicator 11 are mounted on the head 5 can be made up of a more rigid material adapted to provide good resistance on the support 13.

The annular groove 15 cooperating with the support 13 is thus arranged on this lower material M2.

In this alternative embodiment, as illustrated in FIG. 9, the foam applicator 11 is made from two superimposed materials M1 and M2 with different stiffnesses having an identical shape and identical dimensions.

Moreover, the two materials M1 and M2 can be made integral by gluing or lamination.

Furthermore, the foam can be an open-cell cellular material, such as a cured foam, or closed-cell, such as a non-cured foam.

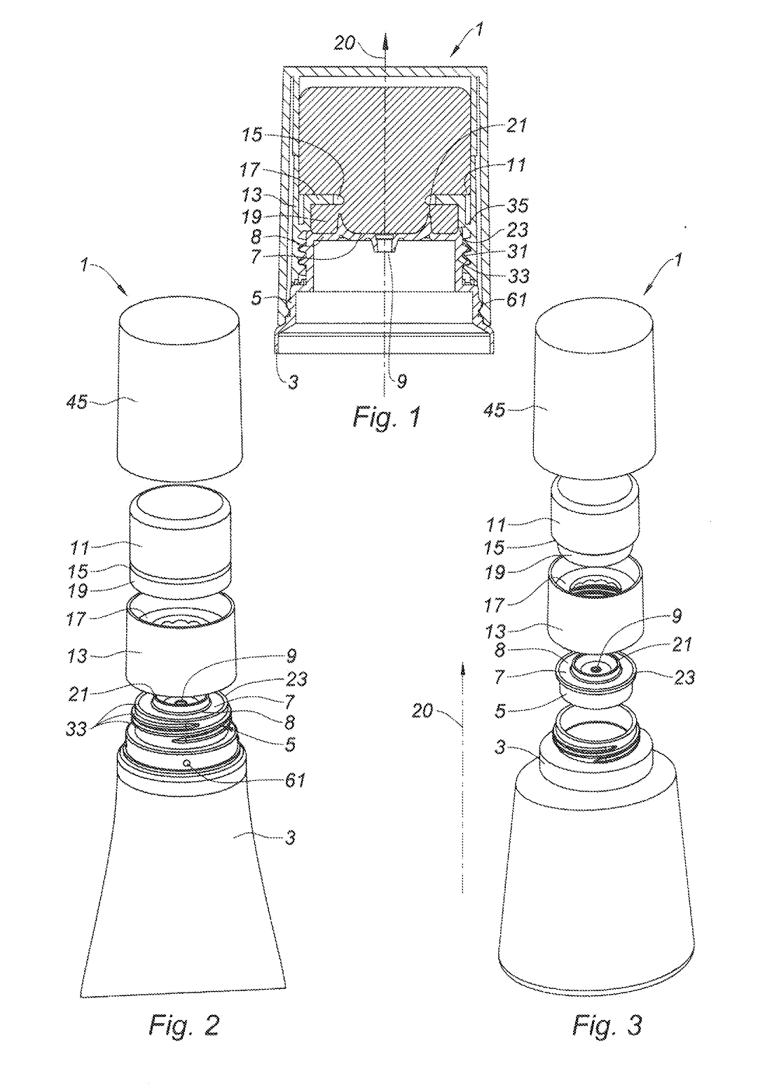

According to the embodiment shown in FIGS. 1 to 3, the applicator 11 is made from a solid open-cell foam and does not include a through orifice. Such a foam allows the diffusion of the fluid contained in the body 3 in the entire volume of the applicator 11 and the arrival over the entire application surface of the applicator 11 as of the first use.

As shown in FIGS. 4 and 5, the applicator 11 can include a through distribution orifice 41 substantially aligned with the outlet orifice 9 of the head. Such a through orifice 41 can be used in the case of a foam applicator 11 or made in a closed-cell cellular material in order to conduct the fluid on the outer surface of the applicator 11. The distribution orifice 41 is called “through” because it goes all the way through the applicator 11.

According to an alternative shown in FIGS. 4 and 5, the distribution orifice 41 of said applicator can be configured to receive a pin 43 of a cover 45 configured to top the support 13.

The pin 43 is then configured to pass through the distribution orifice 41 and close the opening of the head 5. The pin 43 can cover the distribution orifice 41 by jamming or tightening. The diameter of the pin 43 can in particular be between 1 mm and 8 mm. Typically, the pin 43 has a diameter substantially larger than that of the distribution orifice 41 in order to ensure sealing when the cover 45 is installed on the applicator 11 by creating elastic radial tightening. The tightening can in particular be between 0.05 mm and 0.5 mm.

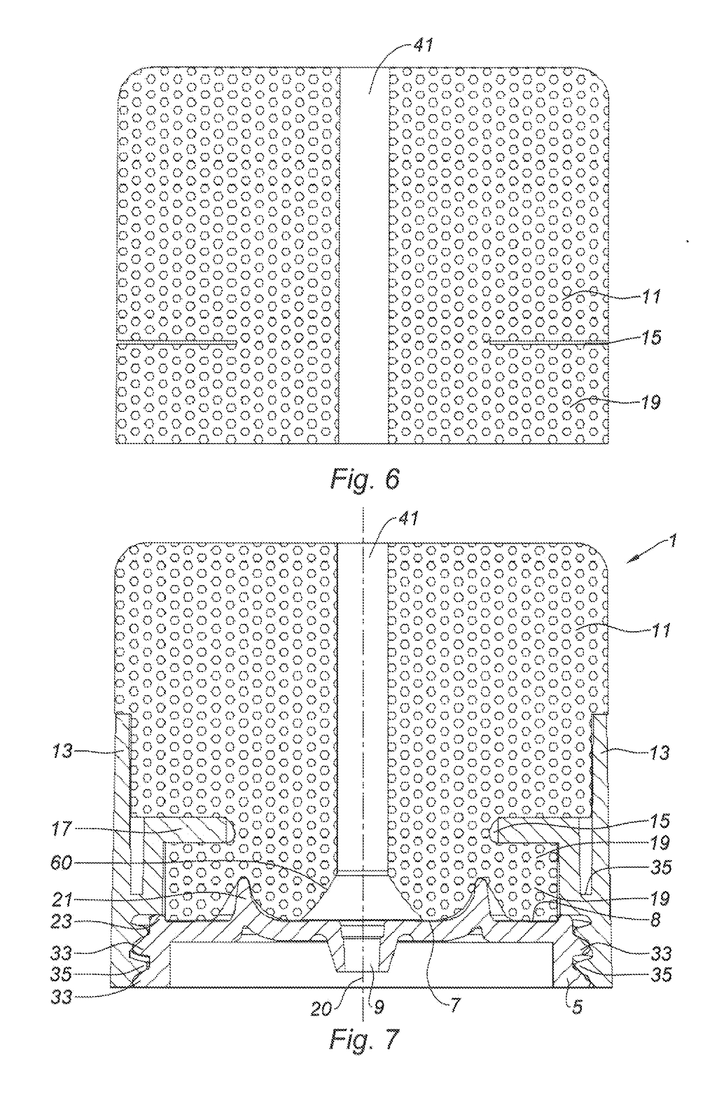

As illustrated in FIG. 6, the applicator 11 can include a distribution orifice 41 passing all the way through it with a tubular shape and a substantially constant diameter.

As illustrated in FIG. 7, the applicator as shown in FIG. 6 can be mounted on the support 13 and on the head 5. The forcible insertion of the applicator 11 on the head 5 of the body creates a flare 60 of the lower portion of the distribution orifice 41.

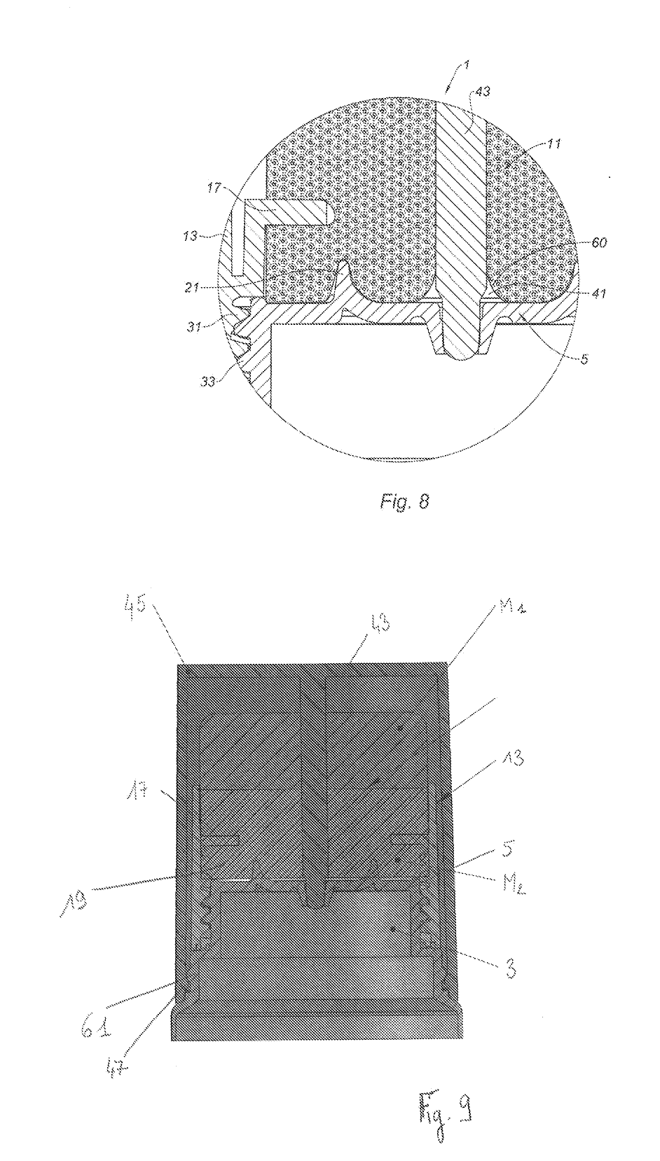

As illustrated in FIG. 8, a pin 43 of a cover can be inserted into said distribution orifice 41 despite said flare 60 of the applicator 11.

It should be noted that, in the alternative embodiment of FIG. 9, the flare 60 of the lower portion of the distribution orifice 41 has not been formed.

Furthermore, in reference in particular to FIG. 9, in which the cover 45 is mounted on the head and the body 3 of the fluid applicator device, the body 3 can also include protruding bosses 61 configured to retain the cover 45.

These bosses 61 are adapted to cooperate with complementary bosses 47 formed protruding on the cover 45, together forming means for fixing the cover 45 of the snap-lock type.

The bosses 47 of the cover 45 are adapted to be housed, through elastic deformation of the cover 45, under the bosses 61 when the cover 45 is mounted, these bosses 61 of the body 3 forming a stop for axial movement of the cover 45.

In one alternative not shown, an opening and closing system is inserted between the support 13 and the head 5 to obstruct or free the outlet orifice 9 of the head.

Examples of such a system include a rotatable plug valve system, a system by screwing freeing an opening, a system of the push/pull type freeing or covering an opening. Such an opening and closing system has the advantage of sealably closing the outlet orifice 9 and therefore the inlet for the fluid contained in the body 3, upstream of the applicator 11, whether or not it is provided with a through orifice.

The device according to the invention 1 has the advantage of being able to easily disassemble the applicator 11 so as, for example, to
manually clean said device 1;
use the applicator 11 separately from the body 3,
use the body 3 without the applicator 11, if necessary,
favor recycling by separating the different materials making up the device according to the invention 1.

1. An applicator device for a fluid, comprising:
a body topped with a head, said head comprising an upper plate with a substantially planar surface and having an outlet orifice to distribute the fluid, said fluid being contained in the body; and
a foam applicator mounted on a support, the foam applicator including an annular groove configured to cooperate with a lateral annular protrusion belonging to said support,
the device being configured so that the lower portion of the applicator situated under the annular groove and intended to be in contact with the head is compressed when the support and the foam applicator are mounted on the head of the body.

2. The device according to claim 1, wherein the support includes an inner shoulder configured to come into contact on the surface of the upper plate when the support is mounted on the head, the height of the space formed by the contact of the inner shoulder on the head being smaller than the height of the lower portion.

3. The device according to claim 1, wherein the applicator includes a through distribution orifice substantially aligned with the outlet orifice of the head.

4. The device according to claim 3, also comprising a cover configured to top the support and provided with a pin configured to come into the distribution orifice.

5. The device according to claim 1, wherein the upper plate includes, on the substantially planar surface, a protruding ring configured to stress the applicator by compression.

6. The device according to claim 5, wherein the protruding ring is assembled on the head.

7. The device according to claim 1, wherein the support includes teeth on the lateral annular protrusion to maintain the foam applicator.

8. The device according to claim 1, wherein an opening and closing system is inserted between the support and the head to obstruct or free the outlet orifice of the head.

9. The device according to claim 1, wherein the head also includes a toroidal ring in relief relative to the surface on which the applicator support is intended to bear.

10. The device according to claim 1, wherein the foam applicator is made from two different superimposed materials, with different stiffnesses.

11. The device according to claim 1, wherein the fluid is a cosmetic product, a medicinal product, a soap, a detergent, a glue, a waxing product, a glazing product, a repellant or a paint.
